(19) United States
(12) Patent Application Publication
(10) Pub. No.: US 2014/0333763 A1
(43) Pub. Date: Nov. 13, 2014

(54) METHOD AND SYSTEM FOR CONTROLLING ACCESS USING A SMART OPTICAL SENSOR

(71) Applicant: Schneider Electric Buildings, LLC, North Andover, MA (US)

(72) Inventors: Glenn Daly, Nashua, NH (US); Christopher LaFleur, Danville, NH (US); Thomas Leedberg, Somerville, MA (US); Michael Morley, Deerfield, NH (US)

(21) Appl. No.: 14/360,084

(22) PCT Filed: Nov. 22, 2011
(86) PCT No.: PCT/US11/61768

§ 371 Date: May 22, 2014

(51) Int. Cl. G06K 9/00; G06T 7/20; H04N 7/18

(52) U.S. Cl. CPC G06K 9/00771; H04N 7/183; G06T 7/20; G06T 2207/30241; G06T 2207/30232; G06T 2207/10016; G06T 2207/10048
USPC 348/135; 348/156

(57) ABSTRACT

The system and method for an access control system using a smart optical sensor to determine whether or not access to a physical location is required. The smart optical sensor can be a stand-alone unit or as a complement to existing access control systems by providing advanced analytics for determining the direction and/or speed of objects in the vicinity of a physical location. The system then takes appropriate action, which can include automatically unlocking and/or opening a door.

### FIELD OF THE INVENTION

The present invention relates to physical access control and more particularly to a smart optical sensor for determining whether or not access to a physical location is to be granted.

### BACKGROUND OF THE INVENTION

In order that doors are automatically actuated, either to open or to unlock, a sensor may be used to detect the presence of a person in the vicinity of the door to trigger the automatic actuation. The sensor is often a PIR (passive infra-red) device that measures infrared (IR) light radiating from objects in its field of view. This arrangement is typically found on automated slide doors where access is unrestricted. This situation is also found where access through a locked door is restricted in one direction (in), bat access from the other direction (out) relies on the door sensor to unlock the door. Currently, these doors unintentionally unlock (or, in the case of automated slide doors, physically open) when people who are not intending to use the door are detected in the FIR detection zone.

### SUMMARY OF THE INVENTION

It has been recognized that a refined system. of access control that can detect the direction and speed of travel of a person can result in a more efficient access control system and potentially increase security for the area. The security is potentially increased by only unlocking and/or opening a door when access is required. With respect to efficiency, the system reduces wear and tear on the door and the actuators by minimizing unnecessary unlocking and/or opening of the door. The system also saves energy by not deploying door locks and actuators on false detection, and by not allowing a HVAC controlled environment to be “contaminated” by unnecessary door openings.

One aspect of the present invention is a system comprising at least one optical input mechanism for providing a live data feed, wherein the optical input mechanism is configured to detect the speed and direction of travel of an object within a field of view; an access control database comprising at least one library containing at least one data representation of interest; an access controller for receiving information from the at least one input mechanism and the access control database, wherein the access controller is configured to compare the live data feed from the optical input mechanism to the data representations in the at least one library to obtain at least one comparison metric, and wherein the access controller is configured to determine, based on the at least one comparison metric, if the live data feed is indicative of a request for access; and an access control point configured to receive information from the access controller indicating a request for access, wherein the access control point then grants access to a physical location.

In one embodiment is an access control system, wherein the field of view of the optical input mechanism comprises a plurality of zones. In one embodiment is an access control system, wherein the field of view of the optical input mechanism comprises a plurality of points.

In one embodiment is an access control system, wherein the optical input mechanism is configured to detect the size of an object within the field of view.

In one embodiment is an access control system, wherein the optical input mechanism is selected from the group consisting of video camera, passive infrared sensor, detector array, radar, and structured light 3D scanner.

In one embodiment is an access control system, wherein the access control database comprises a library consisting of system information. In one embodiment is an access control system, wherein the access control database comprises a library consisting of motion information.

In one embodiment is an access control system, wherein the access control point is selected from the group consisting of actuator, latch, and lock.

Another aspect of the invention is an access control system comprising: at least one optical input mechanism for providing a live data feed, wherein the optical input mechanism is configured to detect the speed and direction of travel of an object within a field of view; an access controller for receiving information from the at least one input mechanism, wherein the access controller is configured to implement a series of finite steps to compare the live data feed from the optical input mechanism to at least one data representation to obtain at least one comparison metric, and wherein the access controller is configured to determine, based on the at least one comparison metric, if the live data feed is indicative of a request for access; and an access control point configured to receive information from the access controller indicating a request for access, wherein the access control point then grants access to a physical location.

In one embodiment is an access control system, wherein the field of view of the optical input mechanism comprises a plurality of zones. In one embodiment is an access control system, wherein the field of view of the optical input mechanism comprises a plurality of points.

In one embodiment is an access control system, wherein the optical input mechanism is configured to detect the size of an object within the field of view.

In one embodiment is an access control system, wherein the optical input mechanism is selected from the group consisting of video camera, passive infrared sensor, detector array, radar, and structured light 3D scanner.

In one embodiment is an access control system, wherein the at least one data representation comprises system information. In one embodiment is an access control system, wherein the at least one data representation comprises motion information.

In one embodiment is an access control system, wherein the access control point is selected from the group consisting of actuator, latch, and lock.

Another aspect of the present invention is a method of detecting whether access to a physical location is requested comprising: capturing a live data feed from at least one optical input mechanism, wherein the data feed comprises data concerning the movement of an object in the field of view of the optical input mechanism; comparing data from the at least one optical input mechanism to at least one data representation to obtain at least one comparison metric; determining that the at least one comparison metric is indicative of a request for access; and signaling an access control point to grant access to a physical location.

In one embodiment is the method of detecting whether access to a physical location is requested, wherein the field of view of the optical input mechanism comprises a plurality of zones. In one embodiment is the method of detecting whether access to a physical location is requested, wherein the field of view of the optical input mechanism comprises a plurality of points.

In one embodiment is the method of detecting whether access to a physical location is requested, wherein, the optical input mechanism is configured to detect the speed and direction of travel of an object within the field of view. In one embodiment is the method of detecting whether access to a physical location is requested, wherein the optical input mechanism is configured to detect the size of an object within the field of view.

In one embodiment is the method of detecting whether access to a physical location is requested, wherein the optical input mechanism is selected from the group consisting of video camera, passive infrared sensor, detector array, radar, and structured light 3D scanner.

In one embodiment is the method of detecting whether access to a physical location is requested, wherein the at least one data representation comprises system information. In one embodiment is the method of detecting whether access to a physical location is requested, wherein the at least one data representation comprises motion information.

In one embodiment is the method of detecting whether access to a physical location is requested, wherein the access control point is selected from the group consisting of actuator, latch, and lock.

These aspects of the invention are not meant to be exclusive and other features, aspects, and advantages of the present invention will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a pictorial representation of the field of view of a smart optical sensor of the present invention.

FIG. 2 is a pictorial representation of the field of view of a smart optical sensor of the present invention, with a path suggestive of a user who requires access to a physical location.

FIG. 3 is a pictorial representation of the field of view of a smart optical sensor of the present invention, with a path suggestive of a user who does not require access to a physical location.

FIG. 4 is a pictorial representation of the field of view of a smart optical sensor of the present invention, with a path suggestive of a user who does not require access to a physical location.

FIG. 5 is a pictorial representation of the field of view of a smart optical sensor of the present invention, with a path suggestive of a user who does not require access to a physical location.

FIG. 6 is a pictorial representation of a smart optical sensor of the present invention as used with a single door.

FIG. 7 is a pictorial representation of a smart optical sensor of the present invention as used with an automatic sliding door.

FIG. 8a is a pictorial representation of a smart optical sensor of the present invention as used to grant access to a physical location, in one direction.

FIG. 8b is a pictorial representation of smart optical sensors of the present invention as used to gut access to a physical location, in both directions.

FIG. 9 is a pictorial representation of the method of granting access to a physical location using the smart optical sensor of the present invention.

### DETAILED DESCRIPTION OF THE INVENTION

The system and method of access control utilizes a smart optical sensor comprising vector recognition (speed and direction) based on an arrangement of zones and/or points that encompass the field of view of the sensor. The orientation of these zones, or points, could form a web, a lattice, or some other network such that the area of interest is adequately captured. This arrangement would enable the system to determine whether a person requires access to a given door, and is not simply passing through a zone, or “meandering” around within a zone.

Currently, doors unintentionally unlock (or, in the case of automated slide doors, physically open) when people who are not intending to use the door are detected in the PIR (passive infra-red) detection zone. A passive infrared sensor is a device that measures infrared (IR) light radiating from Objects in its field of view. Apparent motion is detected when an infrared source with a first temperature, such as a human, passes in front of an infrared source with a second temperature, such as a sidewalk. The sensor doesn't detect the heat from. an object passing in front of it, per se, but rather the object breaks the field of view which the sensor has determined as the “normal” state. Any object, even one having a similar temperature as the background will cause the PIR to activate if it moves in the field of view of the sensors.

This method is similar to the method used in simple video analytics, such as motion detection. There, motion is also detected with regard to a fixed background. In other words, the video analytics look for a change in a certain number of pixels to determine 1) the relative size of the object, and 2) where in the field of view the object is traveling. The smart optical sensor would be able to analyze the image, and based on how long it takes an object to get from one zone to another, it could determine the speed and direction of the object. The sensor could also detect changes in direction.

As noted previously, the smart optical sensor will use various factors within an analytical framework to determine whether a person is requesting access to an area. This will be done using various techniques, but all will use the concept of an arrangement comprised of multiple zones, points, and/or video image field flow as a way of assessing whether there is in fact a request for access. Video image field flow allows for much smaller zones (i.e. as small as pixel-sized), thereby increasing the resolution of vector detection without the need for additional sensors. Generally, there will need to be entry into one of the particular zones closest to the door, but will also likely require certain patterns of approach to the closest zones indicative of a request for access in order to trigger access to the physical location.

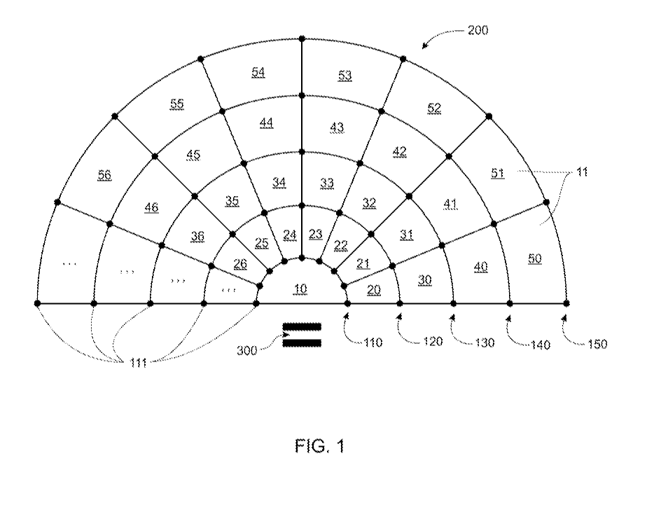

Referring to FIG. 1, the smart optical sensor of the present invention will utilize an arrangement of zones and/or points to encompass the field of view 200. One embodiment would be comprised of a series of zones 11, and another would be comprised of a series of points 111. For example, the arrangement could form concentric rings, such as 10, 20, 30, 40, and 50; or 111, 120, 130; 140, and 150. For simplicity, this representation shows only 5 rings, but depending on the arrangement of the various regions, more or less could be used. This is also true of the radial representation shown There are seven segments radiating from the sensor 300, and are represented as 20, 21, 22, 23, 24, 25, 26, . . . This number could be increased or decreased depending on the technology used (video, PIR, or the like), and the application of interest. Furthermore, the arrangement may not be curved, but linear.

The smart optical sensor will need to break the field of view into multiple zones, or some arrangement of zones and/or points, This can be accomplished in many ways. If using video analytics, it is quite straight forward to set up a grid based on a certain number of blocks of pixels to represent the various zones, or single pixels as points that identify the field flow of the image. If using PIR, the zones could be accomplished using collimated beams, or diffraction grating to form a series of points. The arrangement of zones or points could also be formed by a detector array. The sensor could also utilize a structured light 3D scanner. One important aspect of the present invention is the collection and interpretation of motion data from multiple zones or points which indicate that access to a physical location is requested. A pictorial representation of one possible arrangement of zones is shown in FIG. 1.

Using video analytics and looking for pixel changes, the smart optical sensor can be designed to selectively look for objects in a particular range of sizes or shapes. For example, perhaps the sensor would not grant access to small children. And, the sensor would not grant access to animals, such as squirrels or pets walking around outside the door. Furthermore, if the size of the object is used as one of the factors considered by the analytics of the smart optical sensor, and the door was at a supermarket, or other low security area, the door could prevent small children from activating the door and potentially endangering themselves by leaving the store unsupervised. Size is just one factor that the system will use to determine whether the access is required. In addition to the techniques discussed previously for determining the relative size of an object, the system could also incorporate weight sensors, or could quantify the number of zones touched simultaneously by the object in the FIR context.

Another feature of the smart optical senor would be the ability to process multiple samples. In other words, the sensor would need to be able to accommodate rapid frame rates in either the video analytic or PIR context, or the like. As a user approaches the sensor, the system could use multiple frames to detect the user's distance from the access point, the user's direction of approach, and even determine the speed of the user's approach. The information regarding speed would be useful, for example, if a person were strolling back and forth in front of the door. Then, even if the person were to graze the zone, or multiple zones, in a direction that resembled an approach into the zone directly in front of the door, the analytics of the smart optical sensor could determine, based on the person's previous behavior, that they do not intend to enter, but are merely waiting around outside. The system could also continue to sample and determine that while the person was meandering, he/she is now ready to enter. Perhaps the person was chatting on a cell phone and is now finished with the call and is ready to enter. This is where the advanced analytics of the smart optical sensor could utilize other techniques such as gesture-based knowledge in order to enhance the system's ability to determine when access is actually requested.

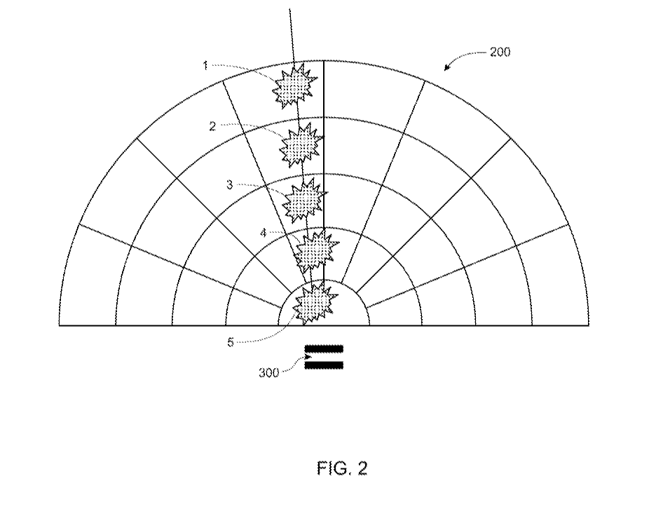

Referring to FIG. 2, the field of view of a smart optical sensor of the present invention is shown with a series of shapes representing the path of travel of an object that indicates a request to access to a secure area. The object approaches the secure area with a continuous movement which the system decodes as a sequence of individual movements denoted by 1,2 ', 2, 3, 4 and 5. Using each movement in reference to the one preceding it and/or following it, the analytics can determine the speed of the object's approach and the direction of that approach. As noted previously, the system can also utilize various analytics to determine the size of the object approaching, to determine the likelihood that it is a user and not some other object.

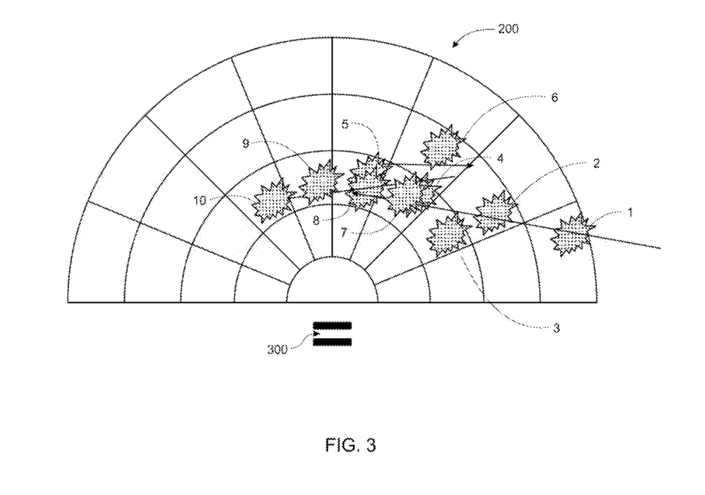

Referring to FIG. 3, the object's movements are best described as meandering in the held of view. Here, the object's path of travel, denoted by numbers 1-10, creates a series of different vectors of different magnitude and direction, The added information of speed and size of the object would be analyzed to discern whether a) it is a user, and if so, b) whether the user is in fact approaching the door and requesting access. As shown here, this series of movements, even if the zones closet to the door were to be entered may not trigger access uncles the penultimate zone in front of the door was also entered. In most cases the system is predictive based on the zone/point sequence. If however, the penultimate zone is entered, the system could have the option to; a) always open the door, or b) keep the door locked as approach was incorrect, depending on the application. Similarly, approach-based access control in the military context, commonly uses signals such that when a soldier is returning from patrol a specific approach route is taken to silently identify friend from foe to any duty guard. A similar principle could be applied to the smart optical sensor where the approach path may be critical to triggering the opening of the door and hence the door may not always open, even on entering the penultimate zone. Additional configurations could be possible to enhance the system's analytics, such as configuring the system so that a specific approach path is specified to indicate a request for access in place of a direct vector of approach. This may also be useful if the regular approach has obstacles (i.e. walls, furniture, etc.) and the triggering approach path needs to be modified.

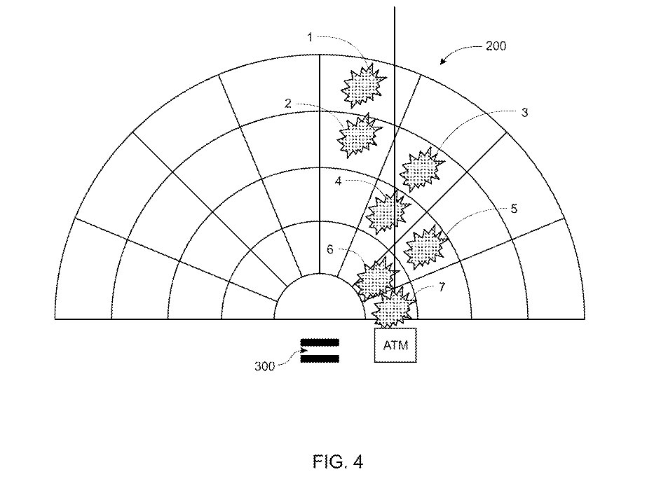

Referring to FIG. 4, the object's movements are in the direction of access to a resource adjacent to the door. Not only are the speed and direction of the potential user analyzed, but the last two movements are considered in light of the fact that there is a resource located adjacent to the door. Thus, the system could intelligently refrain from opening and/or unlocking the door until the penultimate zone is entered, and/or the triggering approach was met.

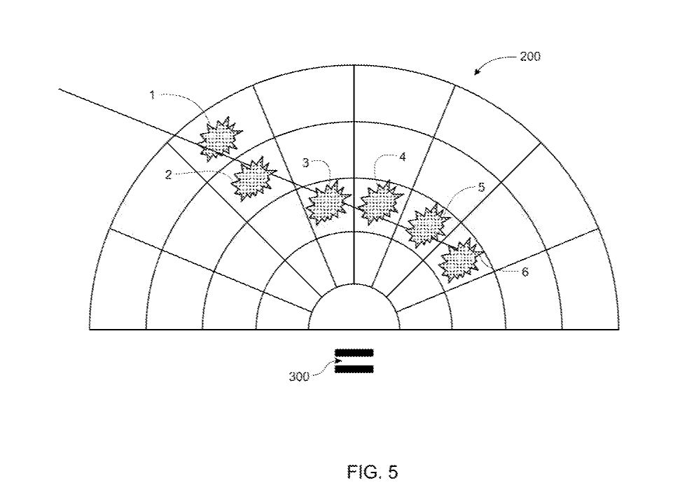

Referring to FIG. 5, the object's movements are suggestive of something passing through the field of view with no intention of requesting access to the area. As discussed previously, the sequence of the object's movements generate speed and direction information. The object's size information and other factors can be considered, such as what is located adjacent to the door, if anything, to inform the system as to the likelihood that the potential user is requesting access to the secure area.

It is recognized that a smart optical sensor system that intelligently determines whether a person intends to exit/enter a door is needed. The smart optical sensor used in the access control system of the present invention increases security by only unlocking a door when exit is required; saves energy by not deploying door locks and actuators on false detection by not allowing a HVAC controlled environment to be “contaminated” by unnecessary door openings; and reduces wear and tear on locks and/or door actuators.

It is recognized that security concerns can be alleviated by using the system of the present invention. For example, with current systems unauthorized users can wait passively outside a physical location with a one-way secure control point and enter when. another user on the other side of the access point inadvertently triggers the door to open and/or unlock by merely passing by or through the sensor's field of view. With the smart optical sensor, the door will only open when the behavior of the user indicates that exit is requested where a “tailgater” would be more likely to be noticed and/or deterred by the authorized user.

In addition to safety concerns there are several examples of energy savings that would be realized with the smart optical sensor of the present invention. For example, in addition to false triggering by human traffic, small animals or debris could not trigger the door actuators by moving into or through the zone. Thus, the door would not open and/or unlock unnecessarily allowing an environmentally controlled area to become “contaminated” by outside air. This could save facilities large amounts of money in heating and cooling costs depending on the temperature differential between the internal and external environments.

The smart optical sensor could integrate with existing camera technology and existing PIR technology, or the like, as an add-on feature; or it could be integrated into a stand-alone ⁻unit which incorporates the advanced analytics in the form of software. The stand-alone smart optical sensor would also utilize the advanced analytics in the form of embedded software. The standalone unit may directly control the door within a closed circuit system (detection, analysis, decision and control) or output the request for access to a centralized access control system. Alternatively, a simple smart optical sensor could be integrated in to an access control system where the analysis, decision and control mechanisms are contained within the access control system core. The smart optical sensor could incorporate detector arrays, or video camera, radar, laser scanning, and the like. The array could define the field of view as well as the individual zones or regions. An array may be comprised of many discrete sensors each dedicated to a zone, a collimated beam, pseudo zones in a video picture, field flow in a video picture, and the like.

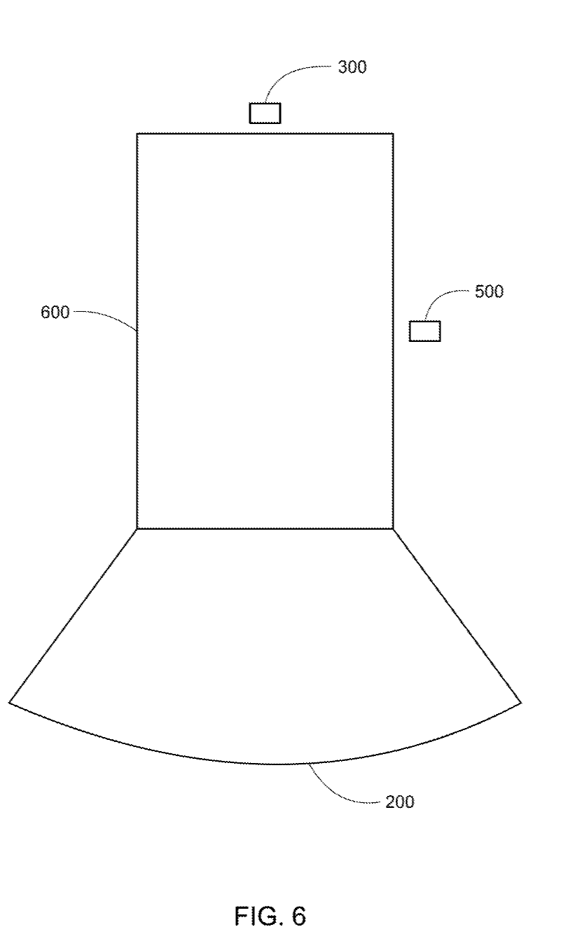

Referring to FIG. 6, the field of view 200 of the smart optical sensor 300 is shown. In this embodiment, the sensor is located above a single door 600. Here, the access control point 500 could be a lock, an actuator, or the like. It is recognized that depending on whether PIR, video analytics, or the like, are used, the location of the sensor could vary, just as the location of the access control point could vary. The access controller 400, not shown, receives input from the optical sensor and compares the input to information in a database or follows a series of finite steps to determine whether access is requested by a user. The access controller could be integrated into the input mechanism 300, or could be external to the input mechanism, or smart optical sensor.

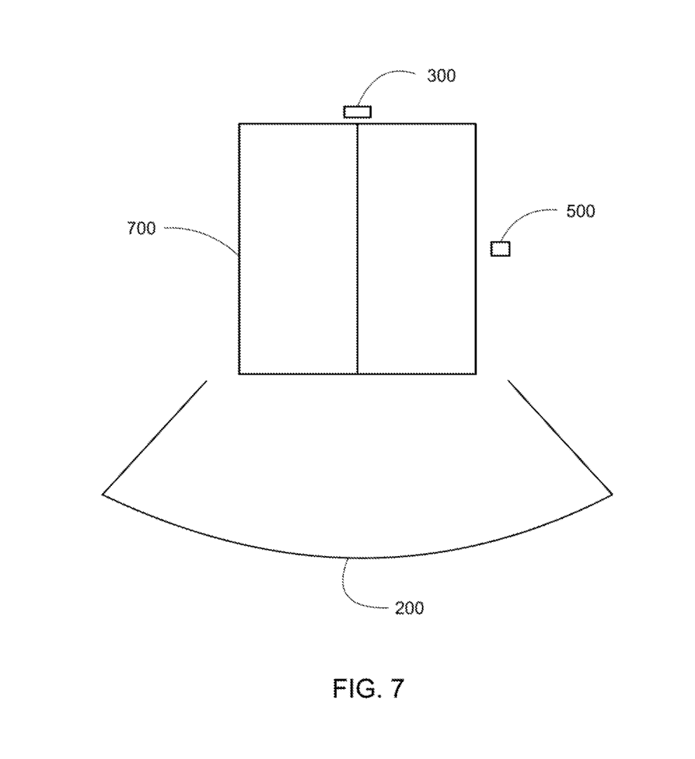

Referring to FIG. 7, the field of view 200 of the smart optical sensor 300 is shown. In this embodiment, the sensor is located above an automatic sliding door 700. Here, the access control point 500 could be a lock, an actuator, or the like. It is recognized that depending on whether PIR, video analytics, or the like, are used, the location of the sensor could vary, just as the location of the access control point could vary. The access controller 400, not shown, receives input from the optical sensor and compares the input to information in a database or follows a series of finite steps to determine whether access is requested by a user. The access controller could be integrated into the input mechanism 300, or could be external to the input mechanism, or smart optical sensor.

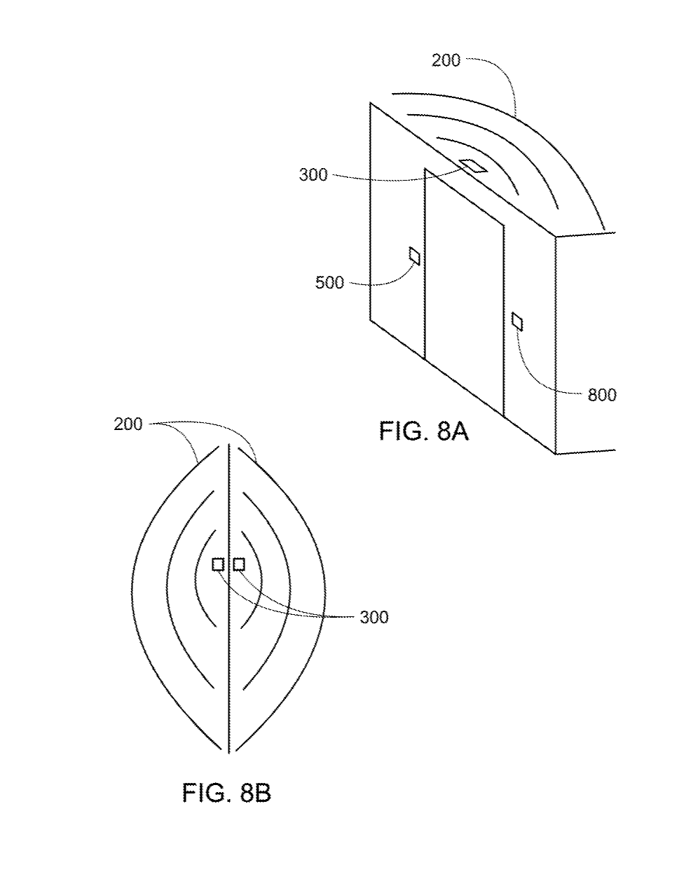

Referring to FIGS. 8a and 8b, the system is shown in use for monitoring a single direction or both directions, depending on the application. FIG. 8a shows a door where credentials are necessary in one direction, but an optical sensor is used to detect requests for access from the other direction. The field of view 200 from the optical sensor 300 is shown on one side of the door. There is a second input mechanism 800, such as a PIN pad or a proximity card reader on the other side of the door. The access control point 500 communicates with both input mechanisms via the access controller 400 to determine when access should be granted. In FIG. 8b, there are two sensors 300 generating two separate fields of view 200. The system analyzes both input streams, much like in FIG. 8a to determine when access should be granted.

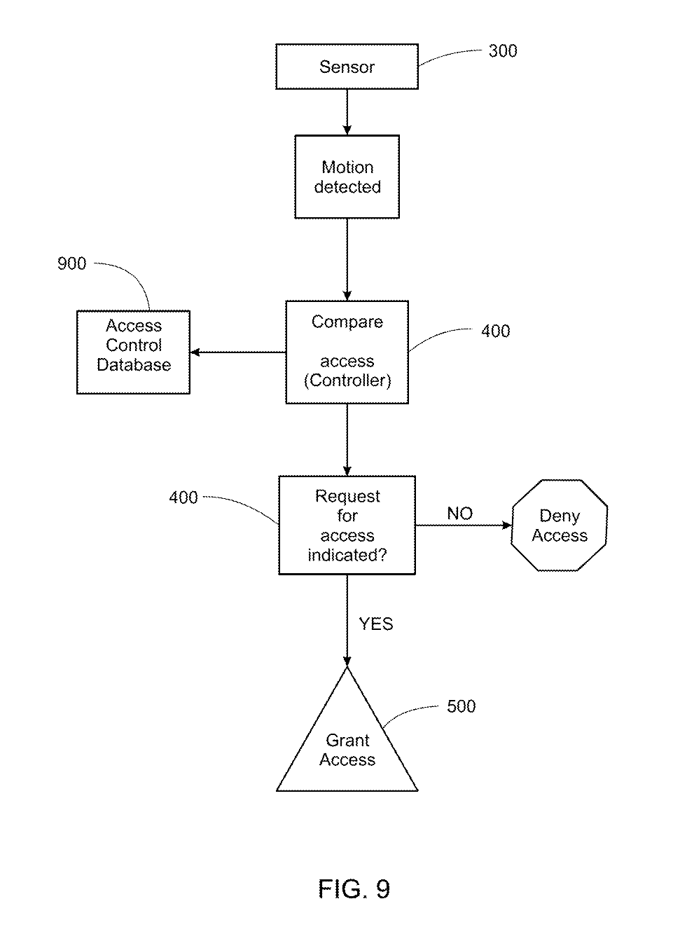

Referring to FIG. 9, the system, generally, receives input from the sensor(s) 300 and when motion is detected, relays the information to an access controller 400 which compares the information to information in an access control database 900 or follows a series of finite steps. The access control database or series of finite steps could incorporate information regarding patterns of behavior, shapes and sizes of various objects; it could also include system information pertaining to the physical location such as the location of any adjacent resources, such as demonstrated in FIG. 4. The database, or series of finite steps could also include information relating to the speed of valid objects, e.g. human, bicycle, car, truck, and the like. Once a configuration indicating a request for access is indicated, based on the comparison performed by the access controller 400, the access control point 500 is signaled and the door opens and/or unlocks. If there is no configuration indicating a request for access, the access control point remains locked and/or closed.

First, the access controller 400 receives what may be a request to grant access to a specific location from an input mechanism 300 for a particular door in a building. In other words, motion is detected by the smart optical sensor, or input mechanism 300. The input mechanism 300 in this case could either be a passive infrared request-to-exit sensor or a video camera, or the like. The system then compares the request for access (motion information) to information stored in the access control database 900 or follows a series of finite steps to determine if access to a physical location is indicated. If so, access control device 500, such as an electronic lock or actuator, would receive the signal to oven and/or unlock and that would be the end of the process.

While stated as comparing image to image, it is recognized by one skilled in the art that cameras and computer vision use mathematical algorithms and convert points in the image, such as a human face or the position of arms and hands, to geometrical relationships. The system is capable of proportionally adjusting the relationship to recognize objects and/or arrangements (position) even if the object and/or arrangement is located in different positions in the image of the camera or distance from the camera.

The arrangements can be selected from a catalog in the video library which is part of the access control database 400. In addition, or in the alternative, an operator can, with the assistance of the system, add specific information relevant to the comparison performed by the access control system 400.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

What is claimed:

1. An access control system comprising:
at least one optical input mechanism for providing a live data feed, wherein the optical input mechanism is configured to detect the speed and direction of travel of an object within a field of view;
an access control database comprising at least one library containing at least one data representation of interest;
an access controller for receiving information from the at least one input mechanism and the access control database, wherein the access controller is configured to compare the live data feed from the optical input mechanism to the data representations in the at least one library to obtain at least one comparison metric, and wherein the access controller is configured to determine, based on the at least one comparison metric, if the live data feed is indicative of a request for access; and
an access control point configured to receive information from the access controller indicating a request for access, wherein the access control point then grants access to a physical location,

2. The access control system of claim 1, wherein the field of view of the optical input mechanism comprises a plurality of zones.

3. The access control system of claim 1, wherein the field of view of the optical input mechanism comprises a plurality of points.

4. The access control system of claim 1, wherein the optical input mechanism is configured to detect the size of an object within the field of view.

5. The access control system of claim 1, wherein the optical input mechanism is selected from the group consisting of video camera, passive infrared sensor, detector array, radar, and structured light 3D scanner.

6. The access control system of claim 1, wherein the access control database comprises a library consisting of system information.

7. The access control system of claim 1, wherein the access control database comprises a library consisting of motion information.

8. The access control system of claim 1, wherein the access control point is selected from the group consisting of actuator, latch, and lock.

9. An access control system comprising:
at least one optical input mechanism for providing a live data feed, wherein the optical input mechanism is configured to detect the speed and direction of travel of an object within a field of view;
an access controller for receiving information from the at least one input mechanism, wherein the access controller is configured to implement a series of finite steps to compare the live data feed from the optical input mechanism to at least one data representation to obtain at least one comparison metric, and wherein the access controller is configured to determine, based on the at least one comparison metric, if the live data feed is indicative of a request for access; and
an access control point configured to receive information from the access controller indicating a request for access, wherein the access control point then grants access to a physical location.

10. The access control system of claim 9, wherein the field of view of the optical input mechanism comprises a plurality of zones.

11. The access control system of claim 9, wherein the field of view of the optical input mechanism comprises a plurality of points.

12. The access control system of claim 9, wherein the optical input mechanism is configured to detect the size of an object within the field of view.

13. The access control system of claim 9, wherein the optical input mechanism is selected from the group consisting of video camera, passive infrared sensor, detector array, radar, and structured light 3D scanner.

14. The access control system of claim 9, wherein the at leant one data representation comprises system information.

15. The access control system of claim 9, wherein the at least one data representation comprises motion information.

16. The access control system of claim 9, wherein the access control point is selected from the group consisting of actuator, latch, and lock.

17. A method of detecting whether access to a physical location is requested comprising:
capturing a live data feed from at least one optical input mechanism, wherein the data feed comprises data concerning the movement of an object in the field of view of the optical input mechanism;
comparing data from the at least one optical input mechanism to at least one data representation to obtain at least one comparison metric;
determining that the at least one comparison metric is indicative of a request for access; and
signaling an access control point to grant access to a physical location.

18. The method of detecting whether access to a physical location is requested of claim 17, wherein the field of view of the optical input mechanism comprises a plurality of zones.

19. The method of detecting whether access to a physical location is requested of claim 17, wherein the field of view of the optical input mechanism comprises a plurality of points.

20. The method of detecting whether access to a physical location is requested of claim 17, wherein the optical input mechanism is configured to detect the speed and direction of travel of an object within the field of view.

21. The method of detecting whether access to a physical location is requested of claim 17, wherein the optical input mechanism is configured to detect the size of an object within the field of view.

22. The method of detecting whether access to a physical location is requested of claim 17, wherein the optical input mechanism is selected from the group consisting of video camera, passive infrared sensor, detector array, radar, and structured light 31) scanner.

23. The method of detecting whether access to a physical location is requested of claim 17, wherein the at least one data representation comprises system information.

24. The method of detecting whether access to a physical location is requested of claim 17, wherein the at least one data representation comprises motion information.

25. The method of detecting whether access to a physical location is requested of claim 17, wherein the access control point is selected from the group consisting of actuator, latch, and lock.
